(19) United States
(12) Patent Application Publication
(10) Pub. No.: US 2014/0358635 A1
(43) Pub. Date: Dec. 4, 2014

(54) MAKING PRODUCT SUBSTITUTION RECOMMENDATIONS

(71) Applicant: International Business Machines Corporation, Armonk, NY (US)

(72) Inventors: Sheng Hua Bao, Beijing (CN); Michael Desmond, White Plains, NY (US); Sophia Krasikov, Katonah, NY (US); Harini Srinivasan, Tarrytown, NY (US); Shiwan Zhao, Beijing (CN)

(21) Appl. No.: 13/904,537

(22) Filed: May 29, 2013

(51) Int. Cl. G06Q 30/06

(52) U.S. Cl. CPC G06Q 30/0631
USPC 705/7.32; 705/26.7

(57) ABSTRACT

Aspects of the invention provide a method for making a product substitution recommendation to a consumer. Initially, a rejection of the product by the consumer is detected. The rejection comprises a failure to purchase a product after the product is added to an online shopping cart, or a return of a product after the product is purchased. Subsequently, a reason for the rejection is determined. A recommendation for a substitute product is then formulated at least in part based on the determined reason for the rejection. Lastly, the recommendation for the substitute product is presented to the consumer.

### CROSS-REFERENCE TO RELATED APPLICATIONS

Not Applicable.

### FIELD OF THE INVENTION

The present invention relates to the electrical, electronic and computer arts, and, more particularly, to electronic commerce and the like.

### BACKGROUND OF THE INVENTION

Recommendation systems seek to predict what product(s) a consumer might prefer, or what rating the consumer might give a product he or she is yet to purchase. Such recommendation systems typically produce a list of recommendations based on inputs such as items previously purchased, items selected or rated by the user, as well as decisions made by similar users. Recommendation systems use sources of data that might include a store's own data, data from third-party agencies, social media sites, etc.

Collaborative filtering is one of the most popular techniques used in recommending products. It filters information using technologies that employ collaboration among multiple agents, viewpoints, data sources, and the like. One of the key factors affecting the performance of collaborative filtering is the method of finding collaborators. Traditionally, collaborative filtering is performed on data to identify consumers with similar product purchase histories, though, recently, collaborative filtering has been performed on consumer feedback as well. Obtaining feedback may involve providing a consumer with a survey so that the consumer can express an opinion about a product, and/or providing a consumer with the ability to select product parameters that most closely reflect that consumer's preferences.

### SUMMARY OF THE INVENTION

Aspects of the invention provide a method for making a product substitution recommendation to a consumer. Initially, a rejection of the product by the consumer is detected. The rejection comprises a failure to purchase a product after the product is added to an online shopping cart, or a return of a product after the product is purchased. Subsequently, a reason for the rejection is determined. A recommendation for a substitute product is then formulated at least in part based on the determined reason for the rejection. Lastly, the recommendation for the substitute product is presented to the consumer.

Moreover, additional aspects of the invention provide a computer program product comprising a computer readable storage medium having computer readable program code embodied therewith. The computer readable program code comprises computer readable program code configured to detect a rejection of a product by a consumer, wherein the rejection comprises a failure to purchase a product after the product is added to an online shopping cart, or a return of a product after the product is purchased. The computer readable program code is also configured to determine a reason for the rejection, and then to formulate a recommendation for a substitute product at least in part based on the determined reason for the rejection. Lastly, the computer readable program code is configured to present the recommendation for the substitute product to the consumer.

Additional aspects of the invention also provide an apparatus comprising a memory and at least one processor coupled to the memory. The at least one processor is operative to detect a rejection of a product by a consumer, wherein the rejection comprises a failure to purchase a product after the product is added to an online shopping cart, or a return of a product after the product is purchased. The at least one processor is also operative to determine a reason for the rejection, and then to formulate a recommendation for a substitute product at least in part based on the determined reason for the rejection. Finally, the at least one processor is operative to present the recommendation for the substitute product to the consumer.

Even additional aspects of the invention also provide an apparatus comprising a means to detect a rejection of a product by a consumer, wherein the rejection comprises a failure to purchase a product after the product is added to an online shopping cart, or a return of a product after the product is purchased. The apparatus also provides a means to determine a reason for the rejection, and a means to formulate a recommendation for a substitute product at least in part based on the determined reason for the rejection. Lastly, the apparatus comprises a means to present the recommendation for the substitute product to the consumer.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial effects. For example, one or more embodiments may provide one or more of the following advantages:
Improved accuracy in providing product substitution recommendations;
Increased automation in providing product substitution recommendations;
Improved customer satisfaction; and
Increased sales by a seller.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a block diagram of a product sales system in accordance with an illustrative embodiment of the invention;

FIG. 2 shows a flow diagram of a method for making a product substitution recommendation utilizing the FIG. 1 product sales system, in accordance with an illustrative embodiment of the invention;

FIG. 3 shows a flow diagram of sub-steps within step 230 of the FIG. 2 method, in accordance with an illustrative embodiment of the invention; and

FIG. 4 depicts a computer system that may be useful in implementing one or more aspects and/or elements of the invention.

### DETAILED DESCRIPTION OF PREFERRED EMBODIMENTS

The present invention will be described with reference to illustrative embodiments. For this reason, numerous modifications can be made to these embodiments and the results will still come within the scope of the invention. No limitations with respect to the specific embodiments described herein are intended or should be inferred.

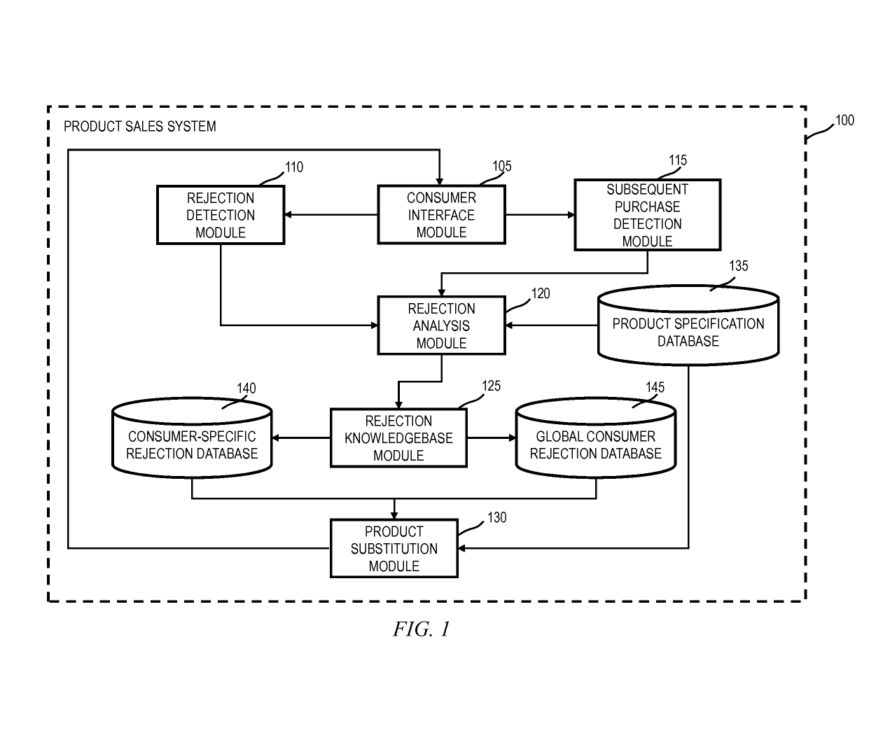

FIG. 1 shows a block diagram of a product sales system 100 in accordance with an illustrative embodiment of the invention. The product sales system 100 comprises a consumer interface module 105, a rejection detection module 110, a subsequent purchase detection module 115, a rejection analysis module 120, a rejection knowledgebase module 125, and a product substitution module 130. The rejection analysis module 120 and the product substitution module 130 are in data communication with a product specification database 135. The rejection knowledgebase module 125 and the product substitution module 130 are in data communication with a consumer-specific rejection database 140 and a global consumer rejection database 145.

In the illustrative product sales system 100, the modules 105, 110, 115, 120, 125, 130 comprise software, which, when executed by one or more data processors in data communication with one or more memories (not specifically shown in FIG. 1, but detailed below), allow the product sales system 100 to implement the desired functionality. The databases 135, 140, 145, in contrast, comprise data storage devices. The product sales system 100 therefore comprises a combination of both hardware and software.

A purpose of the illustrative product sales system 100 is to provide a consumer with a computer-based means by which to purchase products from a seller. A further purpose of the product sales system 100 is to make an appropriate substitute product recommendation in response to the “rejection” of a product by the consumer (i.e., the occurrence of a “product rejection”). A product rejection of the type described herein is likely to be indicative of the consumer's dissatisfaction with the product being rejected. Accordingly, it is contemplated that the recommending of a suitable substitute product that addresses the perceived issues with the rejected product will ultimately act to improve the consumer's level of satisfaction. At the same time, the purchase of the substitute product will provide the seller with a sales advantage. Aspects of the invention, when reduced to practice, thereby provide advantages to both the consumer and the seller.

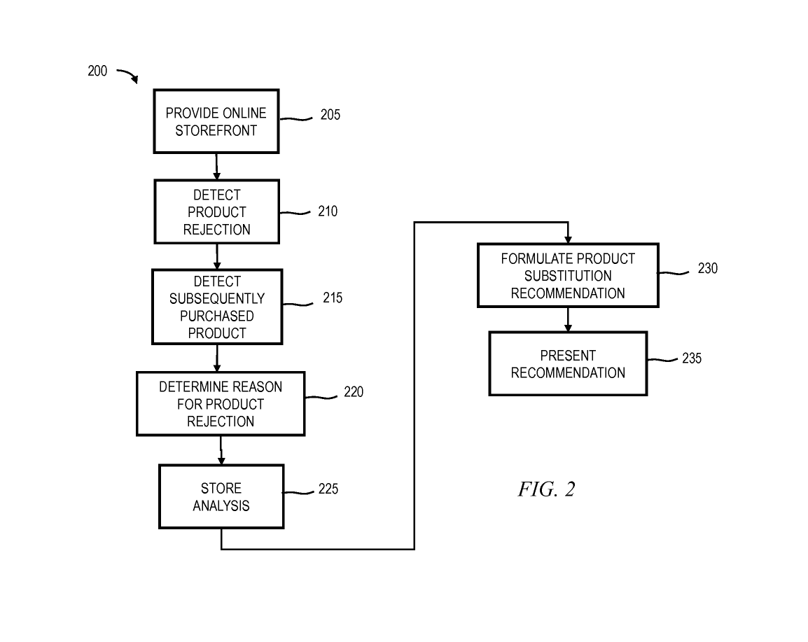

FIG. 2 shows a flow diagram of a method 200 for providing the above-described functionality utilizing the product sales system 100, again, in accordance with an illustrative embodiment of the invention. In step 205 of the method 200, the consumer interface module 105 provides a consumer with an online storefront capable of being accessed via the Internet. In so doing, the product sales system 100 functions as a web server that delivers storefront content to the consumer via, for example, HTML-formatted pages using the TCP/IP set of network protocols. The consumer, in turn, interacts with the online storefront via a web browser or other suitable network application. The network application may be executed on a personal computer, laptop computer, tablet computer, smart cellular telephone, or other network-enabled device controlled by the consumer.

The online storefront allows the consumer to investigate products for sale. In addition, the online storefront provides the consumer with the ability to place one or more products into an online shopping cart. The online shopping cart comprises a list of one or more products that have been selected for purchase. When the consumer is ready to complete the transaction, the consumer activates a “checkout” function. During checkout, the online shopping cart preferably presents the consumer with a total cost for the order along with other relevant data such as, but not limited to, shipping costs and tax costs. The consumer is also given the opportunity to input a form of payment (e.g., credit card information).

Step 210 of the method 200 has the rejection detection module 110 detect a product rejection. There are two different types of product rejections: a drop-type product rejection and a return-type product rejection. In a drop-type product rejection, a consumer adds a product to that consumer's online shopping cart, but fails to actually purchase the product. The consumer may, for example, add the product to the online shopping cart, but eliminate the product before subsequently purchasing an alternative product. In other cases, the consumer may add the product to the online shopping cart, but navigate away from the online storefront before any purchase is made. A drop-type product rejection therefore occurs before a sale of the rejected product (i.e., pre-sale). A return-type product rejection, in contrast, occurs after the product is purchased and delivered to the consumer. After receiving the product, the consumer returns the product to the seller for a refund, exchange, or store credit. A return-type rejection thereby occurs after a sale of the rejected product (i.e., post-sale).

Once a product rejection is detected in step 210, the method 200 progresses to step 215, wherein the subsequent purchase detection module 115 detects any subsequently purchased products. A subsequent purchase can also occur in two different ways, depending on the type of product rejection. As indicated above, in a drop-type product rejection, a consumer may eliminate a product after it is added to the online shopping cart, but then go on to purchase an alternative product. In such a situation, the alternative product forms the subsequently purchased product. In a return-type product rejection, the consumer may request a replacement product as an exchange for a returned product, in which case the product exchanged for the returned product forms the subsequently purchased product. Both types of subsequently purchased products are preferably detected in step 215.

In step 220, the rejection analysis module 120 analyzes the product rejection in order to determine the reason for the product rejection. These functions are performed in conjunction with the product specification database 135. The product specification database 135 contains a table of attributes associated with the various products sold by the seller. The product specification database 135 may, for example, contain data that indicates the respective cost, manufacturer, capabilities, compatibilities, warranty, shipping cost, weight, and other relevant attributes for each product.

If the product rejection that occurred in step 210 is a drop-type product rejection, the rejection analysis module 120 infers the reason for the product rejection. The inference may be based on a subsequently purchased product detected in step 215. If, while interacting with the online storefront in step 205, the consumer, for example, adds a first product to the online shopping cart, but then substitutes a second alternative product for the first product before completing the purchase, the rejection analysis module 120 looks at the differences between the first and second products (i.e., the “distance” between the two products) to infer the reason for the product rejection of the first product. If, as a more specific example, the second product has a better warranty than the first product, but is similar in other attributes, then it may be inferred that the difference in warranty is likely to be the reason for the product rejection. If, as another specific example, the second product is less expensive than the first product, but similar in other respects, then it may be inferred that the difference in price is likely to be the reason for the substitution.

In contrast, in the case of a return-type product rejection, the reason for the product rejection may be collected from the consumer by way of a survey. The survey may, for example, be presented to the consumer when the consumer utilizes the consumer interface module 105 to arrange a return. Again using product attributes available on the product specification database 135, the survey preferably asks the consumer to indicate what attributes resulted in the product rejection. For example, the survey may ask the consumer to indicate whether the return resulted from dissatisfaction with cost, size, manufacturer, weight, warranty, compatibility, reliability, etc. In addition, if, during the return process, the consumer exchanges the rejected product for another product (i.e., there is a subsequently purchased product detected in step 215), the distance between the subsequently purchased product and the returned product may also allow a reason for the product rejection to be inferred in the manner of a drop-type product rejection, as set forth above.

Step 225 has the rejection knowledgebase module 125 store the reason for the product rejection determined in step 220 in both the consumer-specific rejection database 140 and the global consumer rejection database 145. The consumer-specific rejection database 140 associates the reason for the product rejection with the particular consumer that rejected the product. The global consumer rejection database 145, in contrast, stores reasons for product rejections for a multiplicity of consumers so that the data can be used for collaborative filtering.

In accordance with aspects of the invention, step 230 of the method 200 has the product substitution module 130 utilize data from the product specification database 135, the consumer-specific rejection database 140, and the global consumer rejection database 145 to provide a product substitution recommendation to the consumer in response to the product rejection. Such a product substitution recommendation is, of course, of particular value when a product rejection has occurred and no substitute product has been acquired (as detected by step 215).

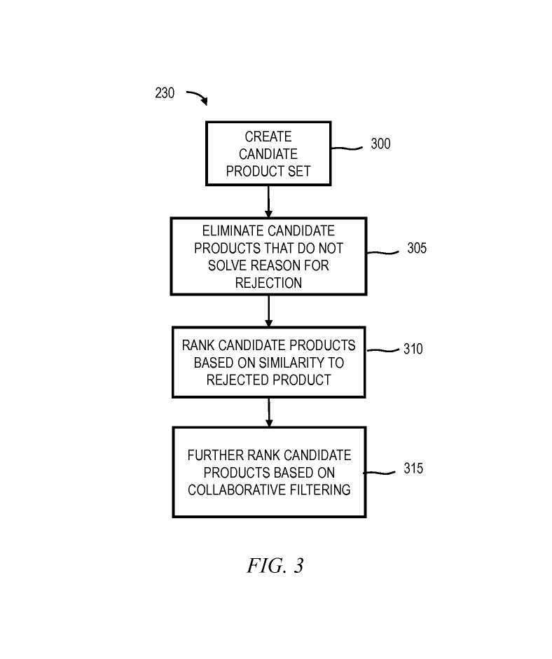

FIG. 3 shows a flow chart that indicates several sub-steps in accordance with an illustrative embodiment of the invention that collectively act to implement step 230 of the method 200. In sub-step 300, the product sales system 100 creates a candidate product set. The candidate product set utilizes data from the product specification database 135 to choose products of the same type as the rejected product. If the rejected product is a digital camera, as just one example, the candidate product set may include other digital cameras available for sale from the seller.

The candidate product set is then refined using sub-steps 305-315. In sub-step 305, the product substitution module 130 eliminates products from the candidate product set that do not have attributes that remedy the determined reason for the product rejection (determined in step 220). In so doing, the attributes of the products in the candidate product set are available in the product specification database 135, while the determined reason for the product rejection is available in the consumer-specific rejection database 140. Stated another way, sub-step 305 compares product attributes and only allows those products with attributes that remedy the determined reason for the product rejection to remain in the candidate product set. Subsequently, in sub-step 310, the remaining products in the candidate product set are ranked by how well their other attributes (i.e., attributes other than those that solve the reason for the product rejection) correspond to those of the rejected product. Those products with greater similarity are given a higher ranking Finally, in sub-step 315, the products in the candidate product set are further ranked by use of a form of collaborative filtering using data from the global consumer rejection database 145. More specifically, those products in the candidate product set that are most often purchased (or received in exchange) by others after making the same product rejection for the same reason as the consumer are given a higher ranking

After refining the candidate product set in this manner, the product with the highest rank in the candidate product set becomes the substitute product to be recommended to the consumer. The product substitution module 130 transmits the identity of this substitute product to the consumer interface module 105. The consumer interface module 105, in turn, presents the substitute product as a product substitution recommendation to the consumer in step 235 of the method 200 utilizing the online storefront interface. In this manner, the product substitution recommendation may be received by the consumer soon after a product rejection is detected in step 210. Naturally, in one or more alternative embodiments, a plurality of substitute products may be included in a given product substitution recommendation rather than just a single substitute product, if the seller so desires.

Given the discussion thus far, it will be appreciated that, in general terms, an exemplary method, according to an aspect of the invention, includes detecting a rejection of a product by a consumer, wherein the rejection comprises either a failure to purchase a product after the product is added to an online shopping cart, or a return of a product after the product is purchased. Subsequently, a reason for the rejection is determined. A recommendation for a substitute product is then formulated at least in part based on the determined reason for the rejection. Lastly, the recommendation for the substitute product is presented to the consumer.

In the non-limiting illustrative embodiment described above with reference to FIGS. 1-3, for example, the rejection detection module 110 detects a product rejection when performing step 210 of the method 200. Subsequently, in step 220, the rejection analysis module 120 determines a reason for the product rejection. The product substitution module 130 then, in step 230 (further broken down into sub-steps 300-315), formulates a substitute product recommendation based on the reason for the product rejection. Lastly, in step 235, the consumer interface module 105 presents the substitute product recommendation to the consumer.

It should again be emphasized, however, that the above-described embodiment of the invention is intended to be illustrative only and is not intended to limit the scope of the invention. Other embodiments can use different types and arrangements of elements and different method steps for implementing the described functionality. As just one particular example, alternative embodiments falling within the scope of the invention may utilize a sequence of method steps very different from that described in FIGS. 2 and 3 for formulating a product substitution recommendation. These numerous alternative embodiments within the scope of the appended claims will be apparent to one skilled in the art.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

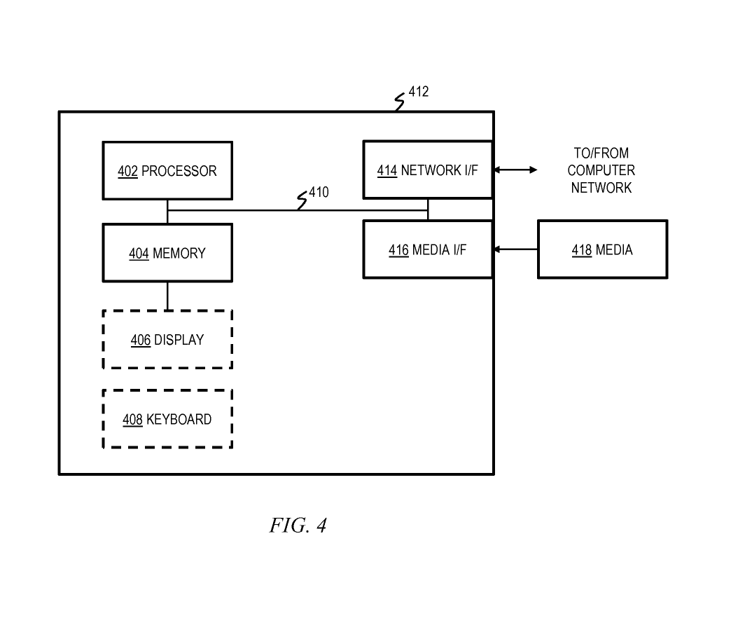

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Additionally, aspects of the invention may be implemented, in whole or in part, utilizing web development languages such as, but not limited to JavaScript. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a rejection detection module, a rejection analysis module, a product substitution module, and a consumer interface module. The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for making a product substitution recommendation to a consumer, the method comprising the steps of:
(a) detecting a rejection of a product by the consumer, the rejection comprising:
i) a failure to purchase a product after the product is added to an online shopping cart; or
ii) a return of a product after the product is purchased;
(b) determining a reason for the rejection;
(c) formulating a recommendation for a substitute product at least in part based on the determined reason for the rejection; and
(d) presenting the recommendation for the substitute product to the consumer.

2. The method of claim 1, further comprising the step of providing the consumer with an online storefront.

3. The method of claim 1, wherein the determining step comprises comparing one or more attributes of the rejected product to one or more attributes of a different product.

4. The method of claim 3, wherein the one or more attributes of the rejected product and the one or more attributes of the different product are received from one or more databases.

5. The method of claim 1, wherein the determining step comprises supplying the consumer with a survey.

6. The method of claim 5, wherein the survey is presented to the consumer via an online interface when the consumer arranges the return of the product.

7. The method of claim 1, wherein the determined reason for the rejection relates to at least one of cost, manufacturer, capability, warranty, size, weight, reliability, shipping cost, and compatibility.

8. The method of claim 1, further comprising the step of storing the determined reason for the rejection in one or more databases.

9. The method of claim 1, wherein the formulating step comprises comparing one or more attributes of the rejected product to one or more attributes of a different product.

10. The method of claim 9, wherein the one or more attributes of the rejected product and the one or more attributes of the different product are received from one or more databases.

11. The method of claim 1, wherein the formulating step comprises finding an alternative product with one or more attributes that at least partially remedy the determined reason for the rejection.

12. The method of claim 1, further comprising the step of identifying alternative products purchased or received in exchange by a plurality of other consumers who have rejected the same product as the consumer for the same reason as the consumer.

13. The method of claim 12, further comprising the step of storing a result of the identifying step in one or more databases.

14. The method of claim 12, wherein the formulating step comprises utilizing a result from the identifying step.

15. The method of claim 1, further comprising providing a system, wherein the system comprises distinct software modules, each of the distinct software modules being embodied on a computer-readable storage medium, and wherein the distinct software modules comprise a rejection detection module, a rejection analysis module, a product substitution module, and a consumer interface module;
wherein:
the detecting step is carried out by the rejection detection module executing on at least one hardware processor;
the determining step is carried out by the rejection analysis module executing on the at least one hardware processor;
the formulating step is carried out by the product substitution module executing on the at least one hardware processor; and
the presenting step is carried out by the consumer interface module executing on the at least one hardware processor.

16. A computer program product comprising a computer readable storage medium having computer readable program code embodied therewith, the computer readable program code comprising computer readable program code configured to perform the steps of:
(a) detecting a rejection of a product by a consumer, the rejection comprising: i) a failure to purchase a product after the product is added to an online shopping cart; or ii) a return of a product after the product is purchased;
(b) determining a reason for the rejection;
(c) formulating a recommendation for a substitute product at least in part based on the determined reason for the rejection; and
(d) presenting the recommendation for the substitute product to the consumer.

17. An apparatus comprising:
a memory; and
at least one processor, coupled to the memory, and operative to perform the steps of:
(a) detecting a rejection of a product by a consumer, the rejection comprising: i) a failure to purchase a product after the product is added to an online shopping cart; or ii) a return of a product after the product is purchased;
(b) determining a reason for the rejection;
(c) formulating a recommendation for a substitute product at least in part based on the determined reason for the rejection; and
(d) presenting the recommendation for the substitute product to the consumer.

18. The apparatus of claim 17, wherein the at least one processor is operative to function as a web server.

19. The apparatus of claim 17, further comprising a plurality of distinct software modules, each of the distinct software modules being embodied on a computer-readable storage medium, and wherein the distinct software modules comprise a rejection detection module, a rejection analysis module, a product substitution module, and a consumer interface module;
wherein:
the at least one processor is operative to detect a rejection of a product by the consumer by executing the rejection detection module, the rejection comprising: i) a failure to purchase a product after the product is added to an online shopping cart; or ii) a return of a product after the product is purchased;
the at least one processor is operative to determine a reason for the rejection by executing the rejection analysis module;
the at least one processor is operative to formulate a recommendation for a substitute product at least in part based on the determined reason for the rejection by executing the product substitution module; and
the at least one processor is operative to present the recommendation for the substitute product to the consumer by executing the consumer interface module.

20. An apparatus comprising:
(a) means for detecting a rejection of a product by a consumer, the rejection comprising: i) a failure to purchase a product after the product is added to an online shopping cart; or ii) a return of a product after the product is purchased;
(b) means for determining a reason for the rejection;
(c) means for formulating a recommendation for a substitute product at least in part based on the determined reason for the rejection; and
(d) means for presenting the recommendation for the substitute product to the consumer.
